(19) United States
(12) Patent Application Publication
(10) Pub. No.: US 2025/0092262 A1
(43) Pub. Date: Mar. 20, 2025

(54) COMBINATION OF SPECIFIC ANNELLATED NAPHTHOPYRANE ISOMERS

(71) Applicant: RODENSTOCK GMBH, Munich (DE)

(72) Inventors: Udo WEIGAND, Munich (DE); Yven ROHLFING, Munich (DE); Herbert ZINNER, Rohrbach (DE)

(21) Appl. No.: 18/728,935

(22) PCT Filed: Jan. 10, 2023
(86) PCT No.: PCT/EP2023/050442

§ 371 Date: Jul. 15, 2024

(30) Foreign Application Priority Data
Jan. 17, 2022 (DE) 10 2022 100 946.7

(51) Int. Cl. C09B 69/10; C09B 67/22; C09K 9/02; C09K 11/06

(52) U.S. Cl. CPC C09B 69/103; C09B 67/0034; C09K 9/02; C09K 11/06

(57) ABSTRACT

The present invention relates to the combination of special photochromic anellated naphthopyran isomers according to the following formulae (I) and (II) and their incorporation into thiourethane polymers.

The present invention relates to the combination of special photochromic anellated naphthopyran isomers according to the following formulae (I) and (II) and their incorporation into thiourethane polymers. These phototropic polymers are characterized by very stable and aesthetic darkening shades. In addition, phototropic products that darken deeply and brighten very quickly can be realized in this way.

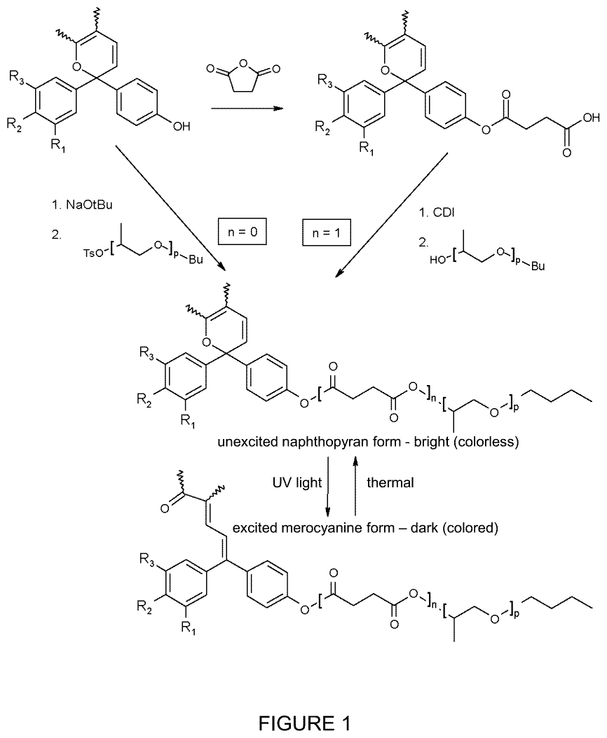

Thiourethane polymers are by far the most widespread materials for plastic spectacle lenses with higher refractive indices of ≥1.60. The higher the refractive index, the thinner a correction spectacle lens can be made. In contrast to acrylate polymers, the incorporation of photochromic dyes into thiourethane polymers has not yet been possible since the dense three-dimensional polymer matrix of the thiourethane thermoset polymers used for plastic spectacle lenses does not provide any room for opening the (colorless) naphthopyran form to form the (colored) merocyanine form by long-wave UV radiation (cf. also FIG. 1). This means that no darkening of the thiourethane polymer can be observed upon UV exposure. For this reason, surface coating with photochromic lacquers—in particular using spin coating— has so far been the method of choice for producing phototropic plastic spectacle lenses with higher refractive indices. However, this process has the disadvantage that complex and expensive technical systems are required and only relatively few products can be produced per unit of time, which is associated with relatively high production costs.

EP 3 351 573 A1 for the first time describes a method for producing mass-colored phototropic thiourethane polymers, which primarily involves the use of a special polyether additive.

It is therefore the object of the present invention to provide systems the incorporation of which, in particular into thiourethane polymers, results in phototropic polymers that are characterized by very stable and aesthetic darkening shades, without the need for such special additives, as is mandatory in EP 3 351 573 A1. Here, it should also be possible to accomplish the incorporation in particular by mass coloring.

This object is solved by the subject matters characterized in the claims.

In particular, the novel combination of two different, specific photochromic anellated naphthopyrans is provided according to the following general formulae (I) and (II):

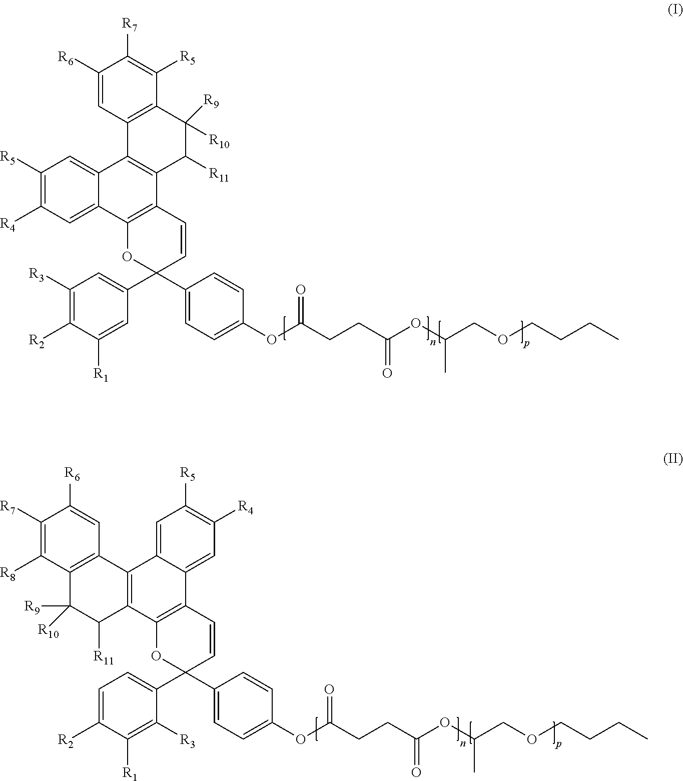

wherein in formulae (I) and (II)
n represents an integer between 0 and 1 and p represents an integer between 10 and 50;
the radicals R₁, R₂ and R₃ each independently represent a substituent selected from hydrogen, bromine, chlorine, fluorine, a (C₁-C₆) alkyl radical, a (C₃-C₇) cycloalkyl radical, a (C₁-C₆)-thioalkyl radical, a (C₁-C₆)-alkoxy radical, a trifluoromethyl radical, a phenyl radical, a 4-methoxyphenyl radical, a phenoxy radical, a 4-methoxyphenoxy radical, a benzyl radical, a 4-methoxybenzyl radical, a benzyloxy radical, a 4-methoxybenzyloxy radical, a biphenyl radical, a biphenyloxy radical, a naphthyl radical, a naphthoxy radical, a diphenylamino radical, a (4-methoxyphenyl)-phenylamino radical, a bis(4-methoxyphenyl)amino radical, a (4-ethoxyphenyl)-phenylamino radical, a bis(4-ethoxyphenyl)amino radical, a 10,10-dimethyl-9,10-dihydroacridine radical, a phenothiazinyl radical, a phenoxazinyl radical, a phenazinyl radical, a carbazolyl radical, a 1,2,3,4-tetrahydrocarbazolyl radical, or a 10,11-dihydro-di-benz[b,f]azepinyl radical;
or the radicals R₁ and R₂ together represent the grouping —V—(CH₂)ₘ—W—, wherein V and W are independently selected from the groupings —O—, —S—, —NC₆H₅—, —CH₂—, —C(CH₃)₂—, —C(C₂H₅)₂— or —C(C₆H₅)₂—; m represents an integer from 1 to 3; provided that if this numerical value is 2 or 3, a benzene ring can also be anellated to two adjacent CH₂ groups; and further provided that V or W, if they represent —CH₂—, together with the respective adjacent CH₂ group can also represent an anellated benzene ring;
the radicals R₄ and R₅ each independently represent a substituent selected from hydrogen, bromine, chlorine, fluorine, a (C₁-C₆) alkyl radical, a (C₃-C₇) cycloalkyl radical, a (C₁-C₆) thioalkyl radical, a (C₁-C₆) alkoxy radical, a trifluoromethyl radical, a phenyl radical, a phenoxy radical, a benzyl radical or a benzyloxy radical;
or the radicals R₄ and R₅ together represent the grouping —X—(CH₂)_{q}—Y—, wherein X and Y are independently selected from the groupings —O—, —S—, —NC₆H₅—, —CH₂—, —C(CH₃)₂—, —C(C₂H₅)₂— or —C(C₆H₅)₂—; q represents an integer from 1 to 3; provided that if this numerical value is 2 or 3, a benzene ring can also be anellated to two adjacent CH₂ groups; and further provided that X or Y, if they represent —CH₂—, together with the respective adjacent CH₂ group can also represent an anellated benzene ring;
the radicals R₆, R₇ and R₈ each independently represent a substituent selected from hydrogen, a (C₁-C₆) alkyl radical, a (C₃-C₇) cycloalkyl radical, a (C₁-C₆) alkoxy radical, a phenyl radical or a benzyl radical;
or the radicals R₆ and R₇ together or R₇ and R₈ together form an anellated benzene ring that may be unsubstituted, monosubstituted or disubstituted, wherein the substituents can be selected from hydrogen, a (C₁-C₆) alkyl radical, a (C₁-C₆) alkoxy radical, a phenyl radical or a benzyl radical;
or the radicals R₆ and R₇ together or R₇ and R₈ together form an anellated naphthalene ring system, an anellated benzofuran ring system, an anellated benzothiophene ring system, an anellated 3,3-dimethylindene ring system or an anellated 2H-chromene ring system;
the radicals R₉, R₁₀ and R₁₁ each independently represent a substituent selected from a (C₁-C₆) alkyl radical or a phenyl radical.

In a preferred embodiment, in the formulae (I) and (II), the radicals R₁, R₂ and R₃ each independently represent a substituent selected from hydrogen, bromine, chlorine, fluorine, and a (C₁-C₆) alkyl radical, a (C₃-C₇)-cycloalkyl radical, a (C₁-C₆)-thioalkyl radical, a (C₁-C₆)-alkoxy radical, a trifluoromethyl radical, a phenyl radical, a 4-methoxyphenyl radical, a phenoxy radical, a 4-methoxyphenoxy radical, a benzyl radical, a 4-methoxybenzyl radical, a benzyloxy radical, a 4-methoxybenzyloxy radical, a biphenyl radical, a biphenyloxy radical, a naphthyl radical, a naphthoxy radical, a diphenylamino radical, a (4-methoxyphenyl)phenylamino radical, a bis(4-methoxyphenyl)amino radical, a (4-ethoxyphenyl)phenylamino radical, a bis(4-ethoxyphenyl)amino radical, a 10,10-dimethyl-9,10-dihydroacridine radical, a phenothiazinyl radical, a phenoxazinyl radical, a phenazinyl radical, a carbazolyl radical, a 1,2,3,4-tetrahydrocarbazolyl radical or a 10,11-dihydro-dibenz[b,f]azepinyl radical.

In a further preferred embodiment, in the formulae (I) and (II), the radicals R₄ and R each independently represent a substituent selected from hydrogen, bromine, chlorine, fluorine, a (C₁-C₆) alkyl radical, a (C₃-C₇) cycloalkyl radical, a (C₁-C₆) thioalkyl radical, a (C₁-C₆) alkoxy radical, a trifluoromethyl radical, a phenyl radical, a phenoxy radical, a benzyl radical or a benzyloxy radical.

In yet a further preferred embodiment, in the formulae (I) and (II), the radicals R₆, R₇ and R₈ each independently represent a substituent selected from hydrogen, a (C₁-C₆) alkyl radical, a (C₃-C₇)-cycloalkyl radical, a (C₁-C₆)-alkoxy radical, a phenyl radical or a benzyl radical.

Preferably, the radicals R₉, R₁₀ and R₁₁ in the formulae (I) and (II) each independently represent a substituent selected from a (C₁-C₆) alkyl radical or a phenyl radical.

The figures show:

FIG. 1 a synthesis scheme for producing the compounds used according to the invention and the way in which they are excited;

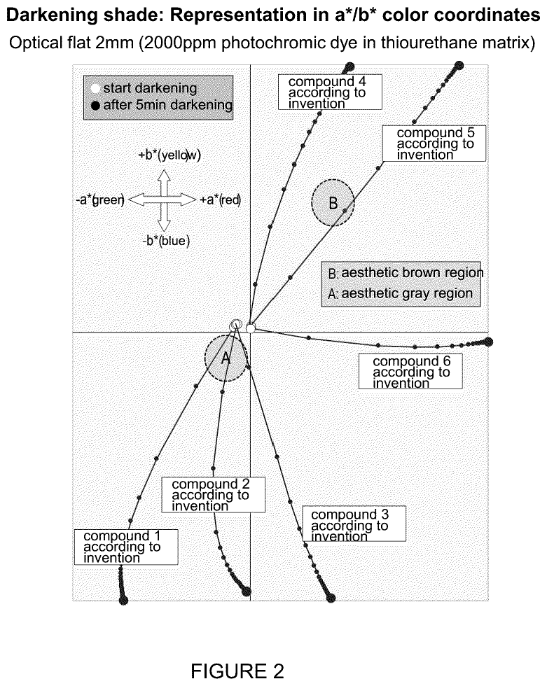

FIG. 2 an illustration of the darkening shades of compounds used according to the invention; and

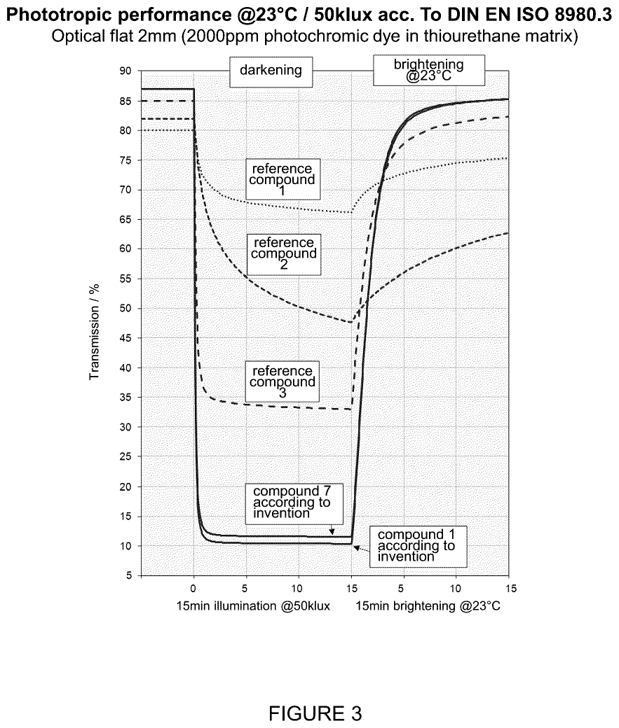

FIG. 3 a comparison of the phototropic performance of compounds used according to the invention with reference compounds that are very similar in structure.

The present invention is based on the surprising finding that the novel combination of photochromic annealed 2H-naphthopyrans according to formula (I) with new photochromic annealed 3H-naphthopyrans according to formula (II) can realize excellent photochromic properties when incorporated into thiourethane polymers. The compounds of formula (II) according to the invention are geometric isomers of 2H-naphthopyrans according to formula (I). The two rings with the substituents R₆ to R₁₁ are anellated to the naphthopyran units. The phototropic thiourethane polymers created on the basis of this combination are characterized by very stable and aesthetic darkening shades. In addition, phototropic products that darken deeply and brighten very quickly can be realized. In addition, the compounds combined according to the invention have a very good durability.

In contrast to EP 3 351 573 A1, in which the use of a special polyether additive is required to produce mass-colored phototropic thiourethane polymers, the present invention solves the problem of incorporation into thiourethane polymers by using this novel combination of two different, specifically tailored photochromic anellated naphthopyran isomers according to the formulae (I) and (II), with which very stable and aesthetic darkening shades can be achieved. The two naphthopyran isomers have different darkening shades, which, when combined, complement each other to create aesthetic gray or brown tones, for example. Here, the 3H-naphthopyran isomers of the formula (II) have yellow-orange to red tones, which is a very important component for the realization of aesthetic brown tones, but also just as important for the realization of aesthetic gray tones as a counterpart to the predominantly blue (blue-violet to blue-green) darkening 2H-naphthopyran isomers of the formula (I) (cf. FIG. 2). This isomer combination is also particularly advantageous because, by choosing suitable substituents, it is relatively easy to match the brightening speeds with each other, which is crucial for the use as mixtures so that the darkening shade remains constant over the entire excitation and lightening cycle.

Compounds according to the formula (I) with oxygen-containing substituents R₄ and R₅ were first presented in EP 3 807 258 for use in all types of plastics.

In contrast to conventional photochromic dyes, which, as already mentioned, do not darken when introduced into compact thiourethane thermoset polymers when exposed to UV light, the naphthopyran isomers according to the invention have an excellent darkening depth due to the attached long poly(propyleneoxy) chains (with p≥10 in formulae (I) and (II)), which are optionally covalently bound to the photochromic dye via a succinic acid ester bridge. Apparently, the presence of the long poly(propyleneoxy) chain modifies the immediate dye environment either sterically (change in the surrounding network density) or electronically (change in the surrounding polarity) in such a way that an opening of the unexcited (colorless) form to form the excited (colored) form is easily possible by long-wave UV radiation. The long poly(propyleneoxy) chain is located close to the photolabile center of the photochromic dye and therefore close to the site of the bond breakage upon excitation or bond recovery upon brightening (cf. FIG. 1) and can thus effect efficient shielding from the thiourethane polymer. An important aspect of the present invention is the unexpected finding that the polarity of the long poly(propyleneoxy) chain is absolutely crucial for good photochromic properties. Both a more polar poly(ethyleneoxy) chain and a more non-polar paraffin chain, with approximately the same chain length, show a significantly poorer phototropic performance (cf. FIG. 3) or do not darken at all upon UV exposure.

The compounds according to the formulae (I) and (II) used according to the invention have a very good durability due to the presence of the three non-hydrogen substituents R₉ to R₁₁ on the two non-aromatic carbon atoms. Corresponding compounds with fewer than three non-hydrogen substituents have a significantly worse durability because they are easily oxidized at this point and colored oxidation products are formed (cf. table 4 below). Three substituents are in fact the optimum here. Four non-hydrogen substituents in the compounds according to formulae (I) and (II) used according to the invention are disadvantageous for steric reasons, since a further substituent on the carbon atom with R₁₁ strongly hinders opening of the (colorless) naphthopyrane form to form the excited (colored) shape by long-wave UV radiation and therefore only a weak darkening can be observed upon UV exposure.

However, in contrast to EP 3 351 573 A1, the scope of the present invention is not limited only to the provision of homogeneously mass-colored thiourethane polymers using the combination according to the invention, but also includes, above all, two-component systems in which a 0.1-1 mm thin phototropic thiourethane functional layer is polymerized onto a polymer base body (sprue method). In addition to attractive manufacturing costs, this method has the great advantage that, in contrast to homogeneously mass-colored products, excellent UV protection for the wearer of glasses can easily be achieved by introducing any amount of UV absorber into the polymer base body. This is not possible with homogeneously mass-colored phototropic thiourethane polymers, since the UV absorbers introduced filter away the long-wave UV light required for darkening from the photochromic dyes. In this respect, the invention also includes sandwich systems in which a 0.1-1 mm thin phototropic thiourethane functional layer is located between two polymer bodies.

Furthermore, the scope of the invention is not limited to the sole presence of the two naphthopyran isomers in thiourethane polymers. In addition to the combination according to the invention, other photochromic dyes (different from those of formulae (I) and (II)), permanent dyes (for pre-colored products), and additives to improve product properties can be used.

The compounds used according to the invention are synthesized from the corresponding anellated naphthopyrans with a 4-hydroxy substituent on the benzene ring, which is bonded to the carbon atom next to the pyran oxygen. According to the synthesis scheme in FIG. 1, the compounds used or combined according to the invention are produced therefrom. The method is identical for the compounds according to formulae (I) and (II). In this respect, only the pyran ring with the two aryl substituents is shown in FIG. 1.

If n represents the number 0, commercially available polypropylene glycol monobutyl ethers (with p≥10 in formulae (I) and (II)) are first activated as tosylate (Ts). The chain length has a Gaussian distribution, i.e. there are mixtures with different chain lengths that are distributed around a maximum. This is followed by covalent connection to the anellated naphthopyrans using a standard Williamson ether synthesis.

If n represents the number 1, the reaction is first carried out with succinic anhydride. The free carboxyl group of the succinic acid unit is then activated with carbonyldiimidazene (CDI), which allows a very mild ester synthesis with the polypropylene glycol monobutyl ether.

The way the excitation works (breaking of the bond by long-wave UV light, creating the colored shape) is also shown in FIG. 1. Brightening back to the unexcited naphthopyran form takes place purely thermally.

To measure the spectral and photochromic properties, the compounds used according to the invention according to formulae (I) and (II) are introduced into an optical thiourethane polymer, i.e. suitable for commercial plastic spectacle lenses. For this purpose, the photochromic dyes are dissolved in the liquid isocyanate component of the thiourethane polymer and, after adding the thiol component and the polyaddition initiator, thermally polymerized using a temperature program. The phototropic performance (darkening and brightening behavior) as well as the darkening shade of the test specimens produced in this way (plane glasses with a thickness of 2 mm) are then determined using standard measurements at 23° C. in accordance with DIN EN ISO 8980-3.

FIG. 2 clearly shows the darkening shades of compounds used according to the invention in a*/b* color coordinates. The molecular structures of the compounds shown in FIG. 2 are listed in tables 1 and 2. The compounds 1, 2, and 3 used according to the invention are described by the formula (III), the compounds 4, 5, and 6 used according to the invention by the formula (IV). Formula (III) represents a subgroup of formula (I), formula (IV) a subgroup of formula (II).

A negative a* value in the a*/b* color coordinate system represents a green darkening shade, a positive a* value represents a red one. A negative b* value represents a blue shade, a positive b* value represents a yellow shade. Mixed colors derived from this, such as violet or orange, can then be found in the area between the respective axes (i.e. between the blue and red axes or the yellow and red axes). The further the measuring point is from the coordinate origin, which by definition represents the absence of color (i.e. shades of gray), the more intense the color is. Measuring points near the coordinate origin symbolize dull shades such as bluish-gray or greenish-gray. A special feature are brown shades, which are a mixture of different basic colors. It has been empirically shown that aesthetic brown colors (e.g. chestnut brown) can be found in the a*/b* color coordinate system in the area of region B.

The darkening shades of the compounds used according to the invention according to formula (III) are located near the blue axis. The shades range from blue-green (compound 1) to blue (compound 2) to blue-violet (compound 3). It was hardly possible to predict the exact colors beforehand due to the complexity of the molecular structures. In contrast, the darkening shades of the compounds used according to the invention according to formula (IV) are found between the yellow and red axes; the shades range from yellow-orange (compound 4) to orange (compound 5) to red (compound 6). This gradient is as expected. The stronger (i.e. the more electron-rich) the donor R₂ is, the more the longest-wave absorption maximum of the excited form shifts bathochromically, from about 450 nm for compound 4 to about 470 nm for compound 5 up to about 530 nm for compound 6.

As stated at the beginning, the subject matter of the present invention is the combination or mixture or system of a dye according to formula (III) or (I) with a dye according to formula (IV) or (II), in order to obtain aesthetic darkening shades when they are suitably matched to one another. For example, in order to achieve an aesthetically gray shade, a combination of the compounds 1 and 5 provided according to the invention can be introduced into the polymer, which together, with the appropriate mixing ratio, create a shade that is close to the coordinate origin in region A (cf. FIG. 2). This is also possible when compounds 2 and 4 are combined. With these combinations, it is always important that the brightening speeds of the partners match-otherwise an undesirable color drift will result during brightening (e.g. from gray to brown if the blue partner is faster brighter than the orange one). The brightening speeds of the combination pairs mentioned (1+5 or 2+4) are therefore coordinated with one another (cf. tables 1 and 2). For a person skilled in the art, this coordination lies within the scope of technical skill.

In order to precisely achieve a desired darkening shade, it can sometimes also be advantageous to use the combination pair 3+6 as an admixture to one of the other two pairs. For example, aesthetically brown darkening shades can be easily achieved, although the combination pair 3+6 does not produce an aesthetically neutral shade when mixed alone (the mixed color of the blue-violet compound 3 and the red compound 6 is violet).

Tables 1 and 2 below show the molecular structures of the compounds shown in FIG. 2 according to the formulae (III) and (IV) as well as their brightening speeds after 2 minutes at 23° C. in the thiourethane polymer.

The compound 2 according to the invention in table 1 has an indeno annulation as substituents R₄ and R₅. The aliphatic carbon atom (with two methyl substituents) of the 3,3-dimethylindene subunit is bonded via R₅, and the benzene ring via R₄. The compound 3 according to the invention in table 1 has a 1,2-ethylenedioxy group as substituents R₄ and R₅.

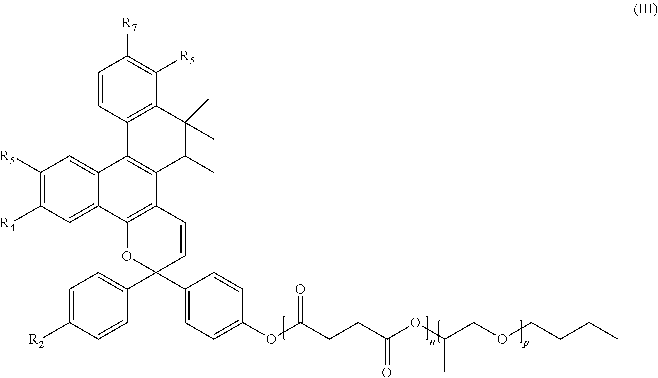

TABLE 1

| | | Relative |
|---|---|---|
| | | brightening |
| | | after 2 min |
| | Substituents in formula (III) | R2 min [%] |
| Compound 1 | p ≈ 42 (Gauss distribution); n = 1 | 65% |
| according to | R2 = NPh2; R4 = OMe; | |
| the invention | R5 = R7 = R8 = H | |
| Compound 2 | p ≈ 42 (Gauss distribution); n = 0 | 60% |
| according to | R2 = NPh2; R4/R5 = o-phenylen-CMe2 | |
| the invention | R7 = R8 = H | |
| Compound 2 | p ≈ 42 (Gauss distribution); n = 1 | 50% |
| according to | R2 = NPh2; R4/R5 = O—CH2CH2—O | |
| the invention | R7/R8 = o-phenylen-O | |

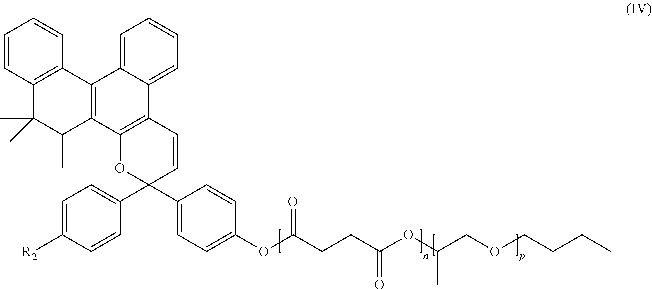

TABLE 2

| | | Relative brightening |
|---|---|---|
| | Substituents in formula (IV) | after 2 min R2 min [%] |
| Compound 4 | p ≈ 42 (Gauss distribution); | 60% |
| according to | n = 0; R2 = H | |
| the invention | | |
| Compound 5 | p ≈ 42 (Gauss distribution); | 65% |
| according to | n = 0; R2 = OEt | |
| the invention | | |
| Compound 6 | p ≈ 42 (Gauss- distribution); | 50% |
| according to | n = 0; R2 = NPh2 | |
| the invention | | |

The brightening behavior from the completely darkened state of the compounds used according to the invention is also listed in table 1 and table 2.

The percentage relative increase in transmission after 2 minutes of brightening is defined as a measure of the brightening behavior, normalized to the overall photochromic stroke of the complete brightening. This practically relevant quantity for describing the photochromic kinetics is called relative brightening R_{2 min}:

$${R}_{2 min} = 100 \times \frac{{τ}_{2 min} - {τ}_{s}}{{τ}_{0} - {τ}_{s}} [ \% ]$$

Here, τ₀ is the light transmittance in the unexcited state;
τ_{S} is the light transmittance in the darkened state;
τ_{2 min} is the light transmittance after 2 min brightening from the darkened state.

The specified percentage value is calculated from the transmission data of the phototropic kinetics measurement according to DIN EN ISO 8980-3 at 23° C. In the first step, the transmission difference between the state after 2 min of brightening and the darkened state previously achieved is determined; in the second step, the transmission difference between the brightened (unexcited) and the darkened state is determined. The ratio of the two transmission differences is multiplied by 100 to obtain a percentage value. A value of 50% R_{2 min} means that after 2 minutes of brightening, half of the photochromic stroke to the fully brightened state has already been completed. The larger the percentage value, the faster the brightening. Commercially available phototropic plastic spectacle lenses have corresponding values between 20% R_{2 min} and 35% R_{2 min} after 2 minutes of brightening, i.e. with the help of the combination according to the invention, it is possible to realize phototropic, high-index plastic spectacle lenses with previously unattainable brightening speeds in combination with excellent darkening depth. The latter is important because such high brightening speeds have so far only been available in conjunction with significantly weaker darkening.

FIG. 3 shows a comparison of the phototropic performance of compounds used according to the invention with reference compounds that are very similar in structure. The molecular structures of the compounds shown in FIG. 3 according to formula (V) are listed in table 3 below. The comparison shows very clearly the improvement achieved by the present invention.

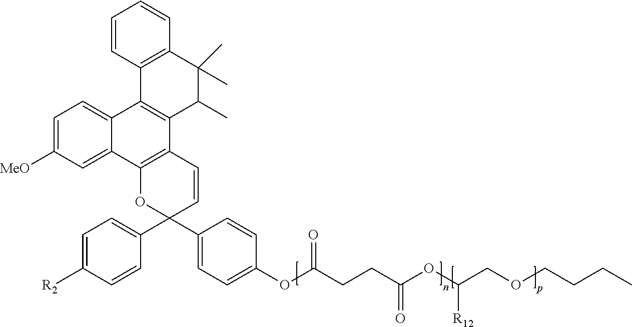

TABLE 3

| | Substituents in formula (V) |
|---|---|
| Compound 1 | R12 = Me; p ≈ 42 (Gauss distribution); |
| according to | n = 1; R2 = NPh2 |
| the invention | |
| Compound 7 | R12 = Me; p ≈ 16 (Gauss distribution); |
| according to | n = 1; R2 = NPh2 |
| the invention | |
| Reference | p = n = 0; R2 = NPh2 |
| compound 1 | |
| Reference | R12 = H; p ≈ 45 (Gauss distribution); |
| compound 2 | n = 1; R2 = NPh2 |
| Reference | R12 = Me; p ≈ 42 (Gauss distribution); |
| compound 3 | n = 1; R2 = N-morpholinyl |

The evaluation of the phototropic performance includes the darkening depth at standard exposure to long-wave UV light as well as the brightening speed at 23° C. A photochromic dye is better the lower the transmission (or the higher the absorption) after UV exposure and the faster the dye returns to its unexcited initial state.

Compounds 1 and 7 used according to the invention only differ in the length of the poly(propyleneoxy) chains. According to the invention, both dyes show excellent darkening and brightening behavior; the shorter chain (with p≈16) is also still effective. However, below a poly(propyleneoxy) chain length of about 10 (p<10), a significant decrease in phototropic performance can be observed. The shielding of the dye from the thiourethane environment is then obviously no longer possible effectively.

The properties of reference compounds 1 and 2 are interesting in comparison. Reference compound 1 has no attached long chain, while reference compound 2 has a chain of practically the same length as compound 1 used according to the invention, but with more polar ethyleneoxy units (R₁₂=H in formula (V)). Both reference compounds show very poor phototropic performance, which clearly shows that only dyes with longer poly(propyleneoxy) chains (R₁₂=Me; Me is the common chemical abbreviation for a methyl group) are suitable for incorporation into thiourethane polymers according to the invention. However, there are limitations, as reference compound 3 shows. It has an N-morpholinyl substituent as radical R₂ in formula (V), in contrast to compound 1 used according to the invention with a diphenylamino substituent at this position. The reference compound 3 darkens significantly less because a considerable part of this photochromic dye decomposes during polymerization. The reason for this is the reactive, basic morpholine unit, which reacts with the isocyanate component of the thiourethane polymer during polymerization. The non-basic diphenyl-amino substituent of compounds 1 and 7 used according to the invention, on the other hand, is inert in this respect. Therefore, these dyes can easily be incorporated into a thiourethane polymer. In general, only dyes with non-basic substituents such as alkyl, aryl, alkyloxy, aryloxy or diarylamino substituents are suitable for this, but not with dialkylamino or arylalkylamino substituents.

Table 4 below shows an example of a comparison of the radiation resistance of compound 5 used according to the invention with structurally very similar reference compounds according to formula (VI).

The remaining photochromic stroke P* after weathering is defined as a measure of radiation resistance:

$${P}^{⋆} = 100 \times \frac{log ( \frac{{τ}_{0}^{⋆}}{{τ}_{s}^{⋆}} )}{log ( \frac{{τ}_{0}}{{τ}_{s}} )} [ \% ]$$

Here, τ₀ is the light transmittance in the unexcited state;
τ_{S} is the light transmittance in the darkened state;
τ₀* the light transmittance in the unexcited state after weathering;
τ_{S}* is the light transmittance in the darkened state after weathering.

Table 4 shows a durability comparison of compound 5 used according to the invention versus reference compounds 4 and 5.

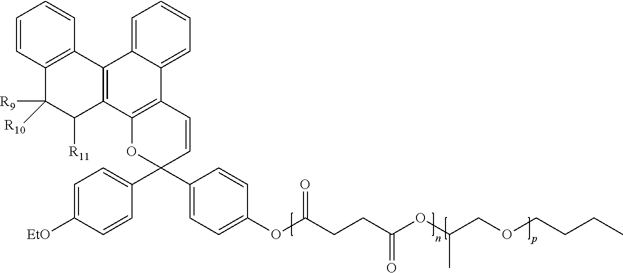

TABLE 4

| | | Radiation resistance |
|---|---|---|
| | | Weathering XeBO |
| | | (50 h @ 700 W/m²) |
| | Substituents in formula (VI) | P*50 h @ 700 W/m² |
| Compound 5 | p ≈ 42 (Gauss distribution); n = 0 | 88% |
| according to | R9 = R10 = R11 = Me | |
| the invention | | |
| Reference | p ≈ 42 (Gauss distribution); n = 0 | 49% |
| compound 4 | R9 = Me; R10 = R11 = H | |
| Reference | p ≈ 42 (Gauss distribution); n = 0 | 34% |
| compound 5 | R9 = R10 = R11 = H | |

The remaining photochromic stroke P* after weathering is determined via the ratio of the extinctions before and after a durability test and is indicated as a percentage of the photochromic stroke of the undamaged test specimen. The test specimens are exposed to intensive irradiation for 50 hours using xenon arc lamps with an irradiance of 700 W/m² in a commercially available weathering device. The measurements are carried out in accordance with the DIN EN ISO 8980-3 standard at 23° C. The larger the specified percentage value, the lower the power loss.

Compound 5 provided according to the invention has very good radiation resistance, due to the presence of three methyl substituents R₉, R₁₀, and R₁₁ on the two non-aromatic carbon atoms. Similar compounds with more hydrogen atoms at these two positions, such as the reference compounds 4 and 5, have significantly poorer radiation resistance because they are easily oxidized at this point and colored oxidation products are formed.

As already noted, the scope of the present invention is not limited to the introduction of the combination of photochromic anellated naphthopyrane isomers according to the invention into thiourethane polymers. In addition, other photochromic dyes can be used.

In addition, permanent dyes (for pre-colored products) and additives can also be used to improve product properties.

The scope of the present invention is also not limited to homogeneously mass-colored thiourethane polymers, but primarily also includes two-component systems in which a 0.1-1 mm thin phototropic thiourethane functional layer is polymerized onto a polymer base body (sprue method). The invention also includes sandwich systems in which a 0.1-1 mm thin phototropic thiourethane functional layer is located between two polymer bodies.

A further subject matter of the present invention relates to the use of the combination of anellated naphthopyran isomers according to the invention for introduction into thiourethane polymers, in particular for ophthalmic purposes, in lenses and glasses for all types of spectacles, such as correction spectacles, driving spectacles, ski goggles, sunglasses, motorcycle goggles, for visors of protective helmets and the like and for sun protection purposes in vehicles and in the construction sector, in the form of windows, protective screens, covers, roofs and the like.

Yet another subject matter of the present invention relates to the novel photochromic anellated naphthopyrans according to the following general formula (II):

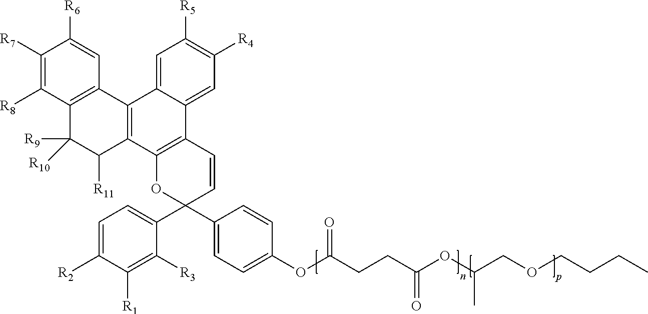

where
n represents an integer between 0 and 1 and p represents an integer between 10 and 50;
the radicals R₁, R₂ and R₃ each independently represent a substituent selected from hydrogen, bromine, chlorine, fluorine, a (C₁-C₆) alkyl radical, a (C₃-C₇) cycloalkyl radical, a (C₁-C₆)-thioalkyl radical, a (C₁-C₆)-alkoxy radical, a trifluoromethyl radical, a phenyl radical, a 4-methoxyphenyl radical, a phenoxy radical, a 4-methoxyphenoxy radical, a benzyl radical, a 4-methoxybenzyl radical, a benzyloxy radical, a 4-methoxybenzyloxy radical, a biphenyl radical, a biphenyloxy radical, a naphthyl radical, a naphthoxy radical, a diphenylamino radical, a (4-methoxyphenyl)-phenylamino radical, a bis(4-methoxyphenyl)amino radical, a (4-ethoxyphenyl)-phenylamino radical, a bis(4-ethoxyphenyl)amino radical, a 10,10-dimethyl-9,10-dihydroacridine radical, a phenothiazinyl radical, a phenoxazinyl radical, a phenazinyl radical, a carbazolyl radical, a 1,2,3,4-tetrahydrocarbazolyl radical, or a 10,11-dihydro-di-benz[b,f]azepinyl radical;
or the radicals R₁ and R₂ together represent the grouping —V—(CH₂)ₘ—W—, wherein V and W are independently selected from the groupings —O—, —S—, —NC₆H₅—, —CH₂—, —C(CH₃)₂—, —C(C₂H₅)₂— or —C(C₆H₅)₂—; m represents an integer from 1 to 3; provided that if this numerical value is 2 or 3, a benzene ring can also be anellated to two adjacent CH₂ groups; and further provided that V or W, if they represent —CH₂—, together with the respective adjacent CH₂ group can also represent an anellated benzene ring;
the radicals R₄ and R₅ each independently represent a substituent selected from hydrogen, fluorine, a (C₁-C₆) alkyl radical, a (C₁-C₆) alkoxy radical, a phenyl radical, a phenoxy radical, a benzyl radical or a benzyloxy radical;
the radicals R₆, R₇ and R₈ each independently represent a substituent selected from hydrogen, a (C₁-C₆) alkyl radical, a (C₃-C₇) cycloalkyl radical, a (C₁-C₆) alkoxy radical, a phenyl radical or a benzyl radical;
or the radicals R₆ and R₇ together or R₇ and R₈ together form an anellated benzene ring that may be unsubstituted, monosubstituted or disubstituted, wherein the substituents can be selected from hydrogen, a (C₁-C₆) alkyl radical, a (C₁-C₆) alkoxy radical, a phenyl radical or a benzyl radical;
or the radicals R₆ and R₇ together or R₇ and R₈ together form an anellated naphthalene ring system, an anellated benzofuran ring system, an anellated benzothiophene ring system, an anellated 3,3-dimethylindene ring system or an anellated 2H-chromene ring system;
the radicals R₉, R₁₀ and R₁₁ each independently represent a substituent selected from a (C₁-C₆) alkyl radical or a phenyl radical.

As far as preferred embodiments of these novel photochromic anellated naphthopyrans according to the general formula (II) are concerned, the above discussion applies.

1. A combination of two different, photochromic anellated naphthopyrans according to the following general formulae (I) and (II): 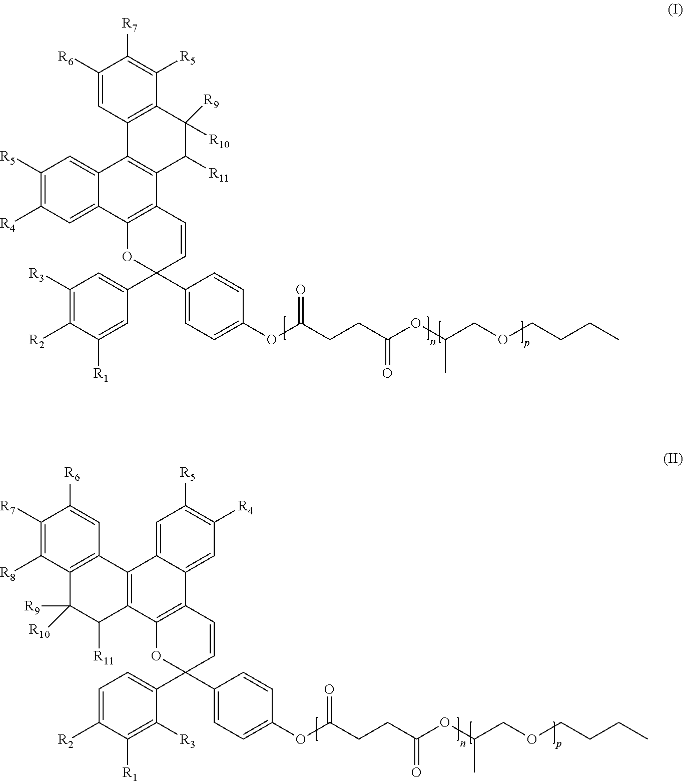
wherein in formulae (I) and (II)
n represents an integer between 0 and 1 and p represents an integer between 10 and 50;
the radicals R₁, R₂ and R₃ each independently represent a substituent selected from hydrogen, bromine, chlorine, fluorine, a (C₁-C₆) alkyl radical, a (C₃-C₇) cycloalkyl radical, a (C₁-C₆)-thioalkyl radical, a (C₁-C₆)-alkoxy radical, a trifluoromethyl radical, a phenyl radical, a 4-methoxyphenyl radical, a phenoxy radical, a 4-methoxyphenoxy radical, a benzyl radical, a 4-methoxybenzyl radical, a benzyloxy radical, a 4-methoxybenzyloxy radical, a biphenyl radical, a biphenyloxy radical, a naphthyl radical, a naphthoxy radical, a diphenylamino radical, a (4-methoxyphenyl)-phenylamino radical, a bis(4-methoxyphenyl)amino radical, a (4-ethoxyphenyl)-phenylamino radical, a bis(4-ethoxyphenyl)amino radical, a 10,10-dimethyl-9,10-dihydroacridine radical, a phenothiazinyl radical, a phenoxazinyl radical, a phenazinyl radical, a carbazolyl radical, a 1,2,3,4-tetrahydrocarbazolyl radical, or a 10,11-dihydro-di-benz[b,f]azepinyl radical;
or the radicals R₁ and R₂ together represent the grouping —V—(CH₂)ₘ—W—, wherein V and W are independently selected from the groupings —O—, —S—, —NC₆H₅—, —CH₂—, —C(CH₃)₂—, —C(C₂H₅)₂— or —C(C₆H₅)₂—; m represents an integer from 1 to 3; provided that if this numerical value is 2 or 3, a benzene ring can also be anellated to two adjacent CH₂ groups; and further provided that V or W, if they represent —CH₂—, together with the respective adjacent CH₂ group can also represent an anellated benzene ring;
the radicals R₄ and R₅ each independently represent a substituent selected from hydrogen, bromine, chlorine, fluorine, a (C₁-C₆) alkyl radical, a (C₃-C₇) cycloalkyl radical, a (C₁-C₆) thioalkyl radical, a (C₁-C₆) alkoxy radical, a trifluoromethyl radical, a phenyl radical, a phenoxy radical, a benzyl radical or a benzyloxy radical;
or the radicals R₄ and R₈ together represent the grouping —X—(CH₂)_{q}—Y—, wherein X and Y are independently selected from the groupings —O—, —S—, —NC₆H₅—, —CH₂—, —C(CH₃)₂—, —C(C₂H₅)₂— or —C(C₆H₅)₂—; q represents an integer from 1 to 3; provided that if this numerical value is 2 or 3, a benzene ring can also be anellated to two adjacent CH₂ groups; and further provided that X or Y, if they represent —CH₂—, together with the respective adjacent CH₂ group can also represent an anellated benzene ring;
the radicals R₆, R₇ and R₈ each independently represent a substituent selected from hydrogen, a (C₁-C₆) alkyl radical, a (C₃-C₇) cycloalkyl radical, a (C₁-C₆) alkoxy radical, a phenyl radical or a benzyl radical;
or the radicals R₆ and R₇ together or R₇ and R₈ together form an anellated benzene ring that may be unsubstituted, monosubstituted or disubstituted, wherein the substituents can be selected from hydrogen, a (C₁-C₆) alkyl radical, a (C₁-C₆) alkoxy radical, a phenyl radical or a benzyl radical;
or the radicals R₆ and R₇ together or R₇ and R₈ together form an anellated naphthalene ring system, an anellated benzofuran ring system, an anellated benzothiophene ring system, an anellated 3,3-dimethylindene ring system or an anellated 2H-chromene ring system;
the radicals R₉, R₁₀ and R₁₁ each independently represent a substituent selected from a (C₁-C₆) alkyl radical or a phenyl radical.

2. The combination according to claim 1, wherein in the formulae (I) and (II)
the radicals R₁, R₂ and R₃ each independently represent a substituent selected from hydrogen, bromine, chlorine, fluorine, a (C₁-C₆) alkyl radical, a (C₃-C₇) cycloalkyl radical, a (C₁-C₆)-thioalkyl radical, a (C₁-C₆)-alkoxy radical, a trifluoromethyl radical, a phenyl radical, a 4-methoxyphenyl radical, a phenoxy radical, a 4-methoxyphenoxy radical, a benzyl radical, a 4-methoxybenzyl radical, a benzyloxy radical, a 4-methoxybenzyloxy radical, a biphenyl radical, a biphenyloxy radical, a naphthyl radical, a naphthoxy radical, a diphenylamino radical, a (4-methoxyphenyl)-phenylamino radical, a bis(4-methoxyphenyl)amino radical, a (4-ethoxyphenyl)-phenylamino radical, a bis(4-ethoxyphenyl)amino radical, a 10,10-dimethyl-9,10-dihydroacridine radical, a phenothiazinyl radical, a phenoxazinyl radical, a phenazinyl radical, a carbazolyl radical, a 1,2,3,4-tetrahydrocarbazolyl radical, or a 10,11-dihydro-di-benz[b,f]azepinyl radical;
the radicals R₄ and R₅ each independently represent a substituent selected from hydrogen, bromine, chlorine, fluorine, a (C₁-C₆) alkyl radical, a (C₃-C₇) cycloalkyl radical, a (C₁-C₆) thioalkyl radical, a (C₁-C₆) alkoxy radical, a trifluoromethyl radical, a phenyl radical, a phenoxy radical, a benzyl radical or a benzyloxy radical;
the radicals R₆, R₇ and R₈ each independently represent a substituent selected from hydrogen, a (C₁-C₆) alkyl radical, a (C₃-C₇) cycloalkyl radical, a (C₁-C₆) alkoxy radical, a phenyl radical or a benzyl radical; and
the radicals R₉, R₁₀ and R₁₁ each independently represent a substituent selected from a (C₁-C₆) alkyl radical or a phenyl radical.

3. The combination according to claim 1, further comprising one or more further components selected from photochromic dyes other than those of formulae (I) and (II), permanent dyes or additives.

4. The combination according to claim 1, wherein in the formulae (I) and (II) the radicals R₉, R₁₀ and R₁₁ each independently represent a substituent selected from a (C₁-C₆) alkyl radical, preferably the radicals R₉, R₁₀ and R₁₁ each represent methyl.

5. A use of the combination according to claim 1 for introduction into thiourethane polymers, in particular for ophthalmic purposes, in lenses and glasses for all types of spectacles, such as correction spectacles, driving spectacles, ski goggles, sunglasses, motorcycle goggles, for visors of protective helmets and the like and for sun protection purposes in vehicles and in the construction sector, in the form of windows, protective screens, covers, roofs and the like.

6. Phototropic thiourethane polymers, comprising the combination according to claim 1.

7. A phototropic product based on a thiourethane polymer according to claim 6, which is a two-component system in which a 0.1-1 mm thin phototropic thiourethane functional layer based on the thiourethane polymer is polymerized onto a polymer base body, or is a sandwich system in which a 0.1-1 mm thin phototropic thiourethane functional layer based on the thiourethane polymer is disposed between two polymer bodies.

8. Photochromic anellated naphthopyrans according to the following general formula (II): 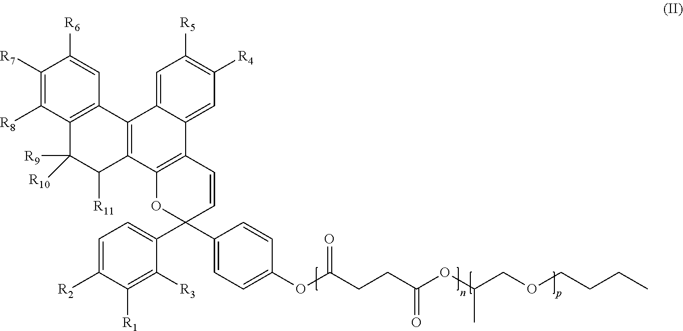
where
n represents an integer between 0 and 1 and p represents an integer between 10 and 50;
the radicals R₁, R₂ and R₃ each independently represent a substituent selected from hydrogen, bromine, chlorine, fluorine, a (C₁-C₆) alkyl radical, a (C₃-C₇) cycloalkyl radical, a (C₁-C₆)-thioalkyl radical, a (C₁-C₆)-alkoxy radical, a trifluoromethyl radical, a phenyl radical, a 4-methoxyphenyl radical, a phenoxy radical, a 4-methoxyphenoxy radical, a benzyl radical, a 4-methoxybenzyl radical, a benzyloxy radical, a 4-methoxybenzyloxy radical, a biphenyl radical, a biphenyloxy radical, a naphthyl radical, a naphthoxy radical, a diphenylamino radical, a (4-methoxyphenyl)-phenylamino radical, a bis(4-methoxyphenyl)amino radical, a (4-ethoxyphenyl)-phenylamino radical, a bis(4-ethoxyphenyl)amino radical, a 10,10-dimethyl-9,10-dihydroacridine radical, a phenothiazinyl radical, a phenoxazinyl radical, a phenazinyl radical, a carbazolyl radical, a 1,2,3,4-tetrahydrocarbazolyl radical, or a 10,11-dihydro-di-benz[b,f]azepinyl radical;
or the radicals R₁ and R₂ together represent the grouping —V—(CH₂)ₘ—W—, wherein V and W are independently selected from the groupings —O—, —S—, —NC₆H₅—, —CH₂—, —C(CH₃)₂—, —C(C₂H₅)₂— or —C(C₆H₅)₂—; m represents an integer from 1 to 3; provided that if this numerical value is 2 or 3, a benzene ring can also be anellated to two adjacent CH₂ groups; and further provided that V or W, if they represent —CH₂—, together with the respective adjacent CH₂ group can also represent an anellated benzene ring;
the radicals R₄ and R₈ each independently represent a substituent selected from hydrogen, fluorine, a (C₁-C₆) alkyl radical, a (C₁-C₆) alkoxy radical, a phenyl radical, a phenoxy radical, a benzyl radical or a benzyloxy radical;
the radicals R₆, R₇ and R₈ each independently represent a substituent selected from hydrogen, a (C₁-C₆) alkyl radical, a (C₃-C₇) cycloalkyl radical, a (C₁-C₆) alkoxy radical, a phenyl radical or a benzyl radical;
or the radicals R₆ and R₇ together or R₇ and R₈ together form an anellated benzene ring that may be unsubstituted, monosubstituted or disubstituted, wherein the substituents can be selected from hydrogen, a (C₁-C₆) alkyl radical, a (C₁-C₆) alkoxy radical, a phenyl radical or a benzyl radical;
or the radicals R₆ and R₇ together or R₇ and R₈ together form an anellated naphthalene ring system, an anellated benzofuran ring system, an anellated benzothiophene ring system, an anellated 3,3-dimethylindene ring system or an anellated 2H-chromene ring system;
the radicals R₉, R₁₀ and R₁₁ each independently represent a substituent selected from a (C₁-C₆) alkyl radical or a phenyl radical.
